(19) United States
(12) Patent Application Publication
(10) Pub. No.: US 2024/0194933 A1
(43) Pub. Date: Jun. 13, 2024

(54) Lithium Secondary Battery And Manufacturing Method For The Same

(71) Applicant: Nippon Telegraph and Telephone Corporation, Tokyo (JP)

(72) Inventors: Hironobu Minowa, Musashino-shi, Tokyo (JP); Akihiro Kono, Musashino-shi, Tokyo (JP); Takeshi Komatsu, Musashino-shi, Tokyo (JP)

(21) Appl. No.: 18/556,258

(22) PCT Filed: May 31, 2021
(86) PCT No.: PCT/JP2021/020688

§ 371 Date: Oct. 19, 2023

(51) Int. Cl. H01M 10/056; H01M 10/052

(52) U.S. Cl. CPC H01M 10/056; H01M 10/052; H01M 2300/0091

(57) ABSTRACT

A positive electrode capable of intercalating and deintercalating lithium ions, a negative electrode capable of intercalating and deintercalating lithium ions, and a solid electrolyte having lithium ion conductivity are provided. In addition, the solid electrolyte includes an inorganic compound and a polymer.

### TECHNICAL FIELD

The present invention relates to a lithium ion secondary battery and a production method thereof.

### BACKGROUND ART

Lithium secondary batteries using intercalation and deintercalation reactions of lithium ions are used all over the world as secondary batteries with high energy density in applications such as various electronic devices, power sources for automobiles, and electric power storage. Even now, research and development of electrode materials and electrolyte materials for lithium secondary batteries is advancing in order to improve performance and reduce costs.

In recent years, with the development of smartphones and IoT devices, lithium secondary batteries have attracted more and more attention as mobile power sources, and as power sources for transparent displays and ultra-thin displays, the flexibility and design of the batteries themselves are sometimes required.

In NPL 1 it has been reported that, as a thin lithium secondary battery, Hayashi and others have produced a thin and bendable battery which exhibits a discharge capacity of about 250 μAh/g at a discharge current of a current density of 0.1 mA/cm².

### CITATION LIST

### Non Patent Literature

[NPL 1] Masahiko Hayashi, et al., “Preparation and electrochemical properties of pure lithium cobalt oxide films by electron cyclotron resonance sputtering”, Journal of Power Sources 189 (2009) 416 to 422.

### SUMMARY OF INVENTION

### Technical Problem

As described above, studies have been made on thin and bendable secondary batteries so far. On the other hand, if it is possible to create transparent batteries using materials with high energy density, it is expected that the range of applications will be greatly expanded, as the design of devices and the possibility of using them in a variety of devices will be enhanced.

The present invention was made in view of the above problems, and an object of the present invention is to provide a lithium secondary battery having excellent charge-discharge cycle characteristics and high energy density, and a method of producing the same.

### Solution to Problem

A lithium secondary battery according to an embodiment of the present invention includes a positive electrode capable of intercalating and deintercalating lithium ions, a negative electrode capable of intercalating and deintercalating lithium ions, and a solid electrolyte having lithium ion conductivity, the solid electrolyte containing an inorganic compound and a polymer.

A method of manufacturing a lithium secondary battery according to an embodiment of the present invention includes a step of forming a positive electrode capable of intercalating and deintercalating lithium ions on a first substrate on which a conductive film is formed, a step of forming a negative electrode capable of intercalating and deintercalating lithium ions on a second substrate on which a conductive film is formed, and a step of disposing a solid electrolyte containing an inorganic compound and a polymer between the first substrate and the second substrate.

### Advantageous Effects of Invention

According to the present invention, it is possible to provide a lithium secondary battery having excellent charge-discharge cycle characteristics and high energy density, and a method of producing the same.

### BRIEF DESCRIPTION OF DRAWINGS

FIG. 1A is a schematic top view showing a configuration of a lithium secondary battery according to an embodiment of the present invention.

FIG. 1B is a schematic cross-sectional view showing a configuration of a lithium secondary battery according to an embodiment of the present invention.

FIG. 2 is a flowchart for describing a procedure of manufacturing a lithium secondary battery according to an embodiment.

FIG. 3 is a diagram showing the light transmittance of the lithium secondary battery of Example 1.

FIG. 4 is a diagram showing initial charge/discharge curves of Examples 1 and 2 and a comparative example.

FIG. 5 is a diagram showing discharge capacities up to 20 cycles in Examples 1 and 2 and a comparative example.

### DESCRIPTION OF EMBODIMENTS

Embodiments of the present invention will be described below with reference to the drawings.

### [Constitution of Lithium Secondary Battery]

A lithium secondary battery of the present embodiment includes a positive electrode capable of intercalating and deintercalating lithium ions, a negative electrode capable of intercalating and deintercalating lithium ions, and an electrolyte having lithium ion conductivity. A positive electrode and a negative electrode are respectively formed on a transparent substrate on which a transparent conductive film is formed. An electrolyte includes a transparent solid electrolyte.

Specifically, the positive electrode contains a substance capable of intercalating and deintercalating lithium ions. The negative electrode contains metallic lithium, a metal capable of forming an alloy with or a lithium, substance capable of intercalating and deintercalating lithium ions.

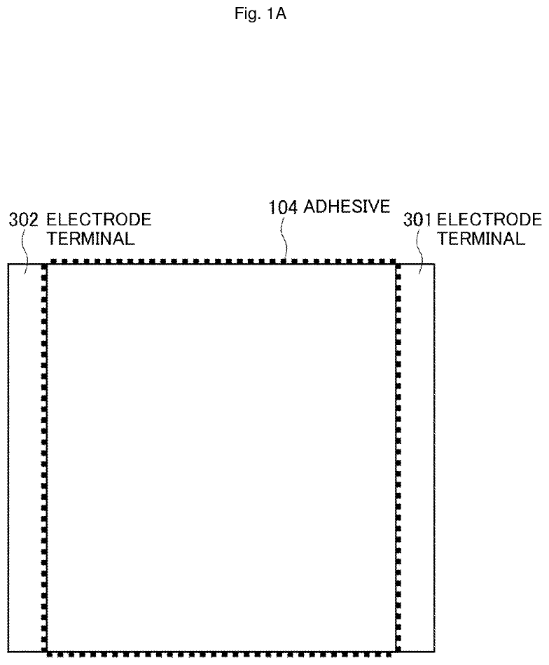

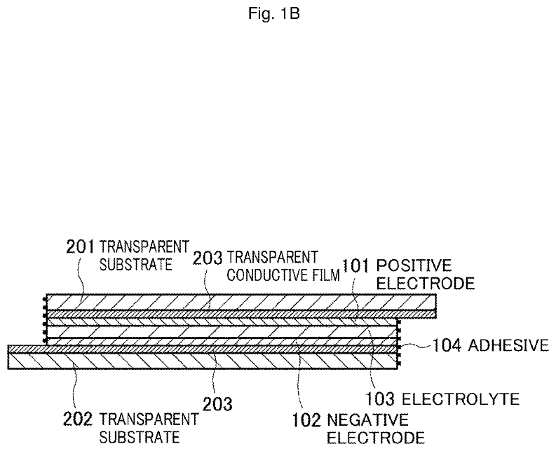

FIGS. 1A and 1B are diagrams schematically showing a configuration of a lithium secondary battery of an embodiment. FIG. 1A is a schematic top view of a lithium secondary battery. FIG. 1B is a schematic cross-sectional view of a lithium secondary battery. The illustrated lithium secondary battery includes a positive electrode 101, a negative electrode 102, and an electrolyte 103 disposed between the positive electrode 101 and the negative electrode 102. The electrolyte 103 is in contact with the positive electrode 101 and the negative electrode 102.

A lithium secondary battery can include a transparent substrate 201 of the positive electrode 101, a transparent substrate 202 of the negative electrode 102, a transparent conductive film 203, and an adhesive 104. In the embodiment, indium tin oxide (ITO) is used for the transparent conductive film 203. Hereinafter, the transparent conductive film 203 is also referred to as an “ITO film 203.”

In the embodiment, the transparent substrates 201 and 202 of the positive electrode 101 and the negative electrode 102 are made of a silicone rubber substrate as a material which is flexible, resistant to creases when bent, readily returns to an original shape thereof, and is highly transparent to visible light.

In the lithium secondary battery, for example, only electrode terminals 301 and 302 of the positive electrode 101 and the negative electrode 102 are exposed to the outside by disposing the positive electrode 101, the negative electrode 102, and the electrolyte 103 as desired on each transparent substrate 201 or 202 on which the ITO film 203 is formed. Also, the lithium secondary battery can be adjusted by sealing with the adhesive 104 to cover the edges of the positive electrode 101, the negative electrode 102, and the electrolyte 103 disposed on the transparent substrates 201 and 202. Note that a seal or the like may be used instead of the adhesive 104 for sealing.

In the embodiment, a transparent solid electrolyte 103 is disposed between the transparent substrate 201 of the positive electrode 101 and the transparent substrate 202 of the negative electrode 102, and sealed in a vacuum using an adhesive 104, a sealing material, or the like. Thus, a lithium secondary battery in which visible light is transmitted and in which separation of the positive electrode 101 and the negative electrode 102 from the transparent substrates 201 and 202 can be prevented can be produced.

Note that, in the lithium secondary battery, the layers 203, 101, and 102 shown in FIG. 1B may not be disposed directly on the transparent substrates 201 and 202 and other members may be disposed between them.

Although the positive electrode 101 and the negative electrode 102 can be produced, for example, by the following method, the present invention is not limited thereto.

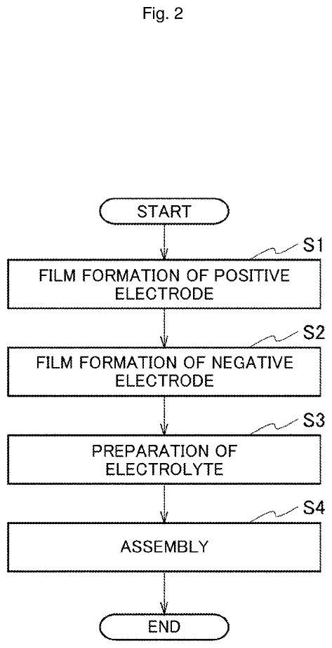

FIG. 2 is a flowchart for describing a procedure for producing the lithium secondary battery of the embodiment.

The positive electrode 101 capable of intercalating and deintercalating lithium ions is formed on a transparent substrate 201 (first substrate) on which a transparent conductive film 203 is formed (Step S1). First, the transparent conductive film 203 such as ITO is formed on the entire transparent substrate 201 such as silicone rubber having flexibility and visible light transmission. The positive electrode 101 is formed by forming film with a predetermined thickness on the transparent conductive film 203 of a transparent substrate 201 from a material capable of intercalating and deintercalating lithium ions. The transparent conductive film 203 and the positive electrode 101 are formed using methods such as sputtering and vapor deposition. Note that the method of film formation is not limited to these.

A thin film layer may be formed between the transparent substrate 201 and the transparent conductive film 203 in forming the positive electrode 101. Specifically, a thin film layer containing at least one selected from the group consisting of Au, Ag, Cu, and Al may be formed on the transparent substrate 201 and the transparent conductive film 203 may be formed on the thin film layer.

Subsequently, the negative electrode 102 capable of intercalating and deintercalating lithium ions is formed on the transparent substrate 202 (second substrate) on which transparent conductive film 203 is formed (Step S2). Similarly to the positive electrode 101, the negative electrode 102 is also formed by forming a transparent conductive film 203 such as ITO on the entire transparent substrate 202 in which visible light is transmitted. In addition, the negative electrode 102 is formed by forming a film of a material capable of intercalating and deintercalating lithium ions with a predetermined thickness on the transparent conductive film 203.

A thin film layer may be formed between the transparent substrate 202 and the transparent conductive film 203 in forming the negative electrode 102. Specifically, a thin film layer containing at least one selected from the group consisting of Au, Ag, Cu, and Al may be formed on the transparent substrate 202 and the transparent conductive film 203 may be formed on the thin film layer.

Subsequently, the transparent electrolyte 103 is prepared (Step S3). The electrolyte 103 is preferably a solid electrolyte. More preferably, the solid electrolyte contains an inorganic compound and a polymer.

As the electrolyte 103 in the embodiment, a solid electrolyte which is a substance having lithium ion conductivity, does not have electronic conductivity, and is transparent to visible light can be used. For example, as solid electrolytes, at least one selected from the group consisting of LISICON type, perovskite type, or garnet type oxides composed of Li, Ba, Ca, Cl, Y, La, Sr, Cu, Bi, Zr, Ta, Nb, and the like, oxynitrides such as Li_{3.3}PO_{3.8}N_{0.22} (LiPON), glass-ceramics composed of Li, Ge, P, S, Si, Cl, and the like, sulfides such as Thio-LISICON, and hydrides such as LiBH₄, 3LiBH₄—LiI, Li₂(CB₉H₁₀)(CB₁₁H₁₂) can be used. LiPON is a transparent amorphous film which exhibits lithium ion conductivity by partially substituting nitrogen for oxygen in Li₃PO₄.

Also, as the solid electrolyte, a flexible or pliable polymer electrolyte to which a polymer that is an organic material is added may be used. As the polymer electrolyte, for example, a solution obtained by dissolving polytetrafluoroethylene (PTFE) or polyvinylidene fluoride (PVdF) and lithium salt in tetrahydrofuran (THF) can be used.

When only inorganic materials are used for the solid electrolyte, a certain degree of flexibility can be obtained, but in order to increase the transmittance, it needs to be made very thin, when the thickness is reduced, the solid electrolyte film will crack when bent, increasing the risk of short-circuiting the positive and negative electrodes. Polymers (organic materials) are highly transparent and flexible even in thick films and can be material-designed to be resistant to breakage even when bent, and the flexibility thereof serves as a physical buffer for the inorganic thin films of the positive and negative electrodes and prevents them from peeling off from the current collector due to cracks.

Furthermore, the electrolyte 103 can also be used by being impregnated in a translucent separator such as polyethylene (PE), polypropylene (PP), and ion-exchange film. For example, the lithium secondary battery may include a separator between the positive electrode 101 and the negative electrode 102. In this case, the translucent separator impregnated with a liquid electrolyte can be used. In addition, the liquid electrolyte such as an organic electrolyte or an aqueous electrolyte may be solidified by being impregnated in a polymer electrolyte or the like.

Subsequently, the electrolyte 103 is placed between the transparent substrate 101 with the positive electrode 101 and the transparent substrate 102 with the negative electrode 102 to assemble a lithium secondary battery (Step S4). First, the electrolyte 103 is formed to have a predetermined size. Furthermore, the transparent substrate 201 of the positive electrode 101, the electrolyte 103, and the transparent substrate 202 of the negative electrode 102 overlap so that the electrode terminals 301 and 302 of the positive electrode 101 and the negative electrode 102 are exposed to the outside. The positive electrode 101, the negative electrode 102, and the electrolyte 103 disposed on the transparent substrates 201 and 202 are sealed with the adhesive 104 to cover the edges thereof to produce a lithium secondary battery.

Examples of the lithium secondary battery of the embodiment will be described in detail below. Note that the present invention is not limited to the examples shown below, but can be modified as appropriate without changing the gist and the scope of the present invention.

### Example 1

A lithium secondary battery of Example 1 was prepared by the following procedure. In Example 1, a solid electrolyte containing an inorganic compound and a polymer was used as an electrolyte 103. The inorganic compound includes at least one selected from the group consisting of Li₃PO₄ and Li_{6.25}La₃Zr₂Ga_{0.25}O₁₂. In Example 1, a lithium secondary battery using a polymer electrolyte to which Li₃PO₄ powder was added and a lithium secondary battery using a polymer electrolyte to which Li_{6.25}La₃Zr₂Ga_{0.25}O₁₂powder was added were prepared.

(Transparent Silicone Rubber Substrate with ITO)

In Example 1, the transparent substrates 201 and 202 of the positive electrode 101 and the negative electrode 102 each use a transparent silicone rubber substrate measuring 100 mm long×100 mm wide and 2 mm thick. Each of the silicone rubber substrates 201 and 202 was coated with ITO to have a thickness of 150 nm as a transparent conductive film 203 through an RF sputtering method to form a film. Sputtering was performed using an ITO (5 wt % SnO₂) target with an argon flow of 1.0 Pa and an RF output of 100 W.

### (Positive Electrode)

A film of lithium cobaltate phosphate (LiCoPO₄) with a thickness of 100 nm was formed as the positive electrode 101 on 10 mm long×100 mm wide of the silicone rubber substrate 201 on which the ITO film was formed through an RF sputtering method. Sputtering was performed using a LiCoPO₄ ceramic target under the conditions of a flow partial pressure ratio of argon and oxygen of 3:1, a total gas pressure of 3.7 Pa, and an RF output of 700 W.

The positive electrode 101 thus formed has a portion of 10 mm long×100 mm wide in which the positive electrode material is not formed and the ITO is exposed. The exposed portion is used as the electrode terminal 301 of the positive electrode 101.

### (Negative Electrode)

A film of lithium titanate (Li₄Ti₅O₁₂) was formed to have a thickness of 200 nm as the negative electrode 102 through an RF sputtering method on a silicone rubber substrate 202 having an ITO film formed thereon and having 90 mm long×100 mm wide. Sputtering was performed using a Li₄Ti₅O₁₂ceramic target under the conditions of a flow partial pressure ratio of argon and oxygen of 3:1, a total gas pressure of 4.0 Pa, and an RF output of 700 W.

The negative electrode 102 thus formed has a portion of 10 mm long×100 mm wide in which the negative electrode material is not formed and the ITO is exposed. The exposed portion is used as the electrode terminal 302 of the negative electrode 102.

### (Electrolyte)

In the example, the solid electrolyte containing an inorganic compound and a polymer was used as the electrolyte 103. Specifically, polyvinylidene fluoride (PVdF) powder as a binder, a Li₃PO₄ powder or a Li_{6.25}La₃Zr₂Ga_{0.25}O₁₂powder, an organic electrolyte solution in which 1 mol/L of lithium bistrifluoromethanesulfonylimide (LiTFSI) as a lithium salt is dissolved in propylene carbonate (PC), and tetrahydrofuran (THF) as a dispersion medium were mixed at a weight ratio of 3:1:6:10. A transparent film (polymer electrolyte) with a thickness of 0.1 mm was prepared by stirring the solution at 60° C. for 1 hour in dry air with a dew point of −50° C. or lower, pouring 50 ml of the solution into a petri dish of 200Φ, and vacuum-drying it at 50° ° C. for 12 hours.

### (Battery Preparation)

The polymer electrolyte 103 was formed to have a size of 90 mm long and 100 mm wide. The positive electrode 101 and the negative electrode 102 are pinched so that the film-forming surfaces of the polymer electrolyte 103 face each other and only the film-forming surfaces are entirely covered and the transparent substrate 201 of the positive electrode 101, the polymer electrolyte 103, and the transparent substrate 202 of the negative electrode 102 overlap. The edge of 90 mm long×100 mm wide of the overlapped part in which the positive electrode 101, the polymer electrolyte 103, and the negative electrode 102 overlapped was sealed with an adhesive 104. In addition, before the adhesive 104 was hardened, it was placed in a vacuum dryer and vacuum-dried to solidify the adhesive 104 to produce a lithium secondary battery.

### (Battery Performance)

In the charge/discharge test of the lithium secondary battery, charge/discharge was performed at a current density of 1 μA/cm² per effective area of positive electrode 101 (negative electrode 102) using a commercially available charge/discharge measurement system. The charging/discharging test was performed in a voltage range of 4.0 V for the final charge voltage and 2.0 V for the final discharge voltage. The charge/discharge test of the battery was performed in a constant temperature chamber at 25° C. (atmosphere is a normal atmospheric environment).

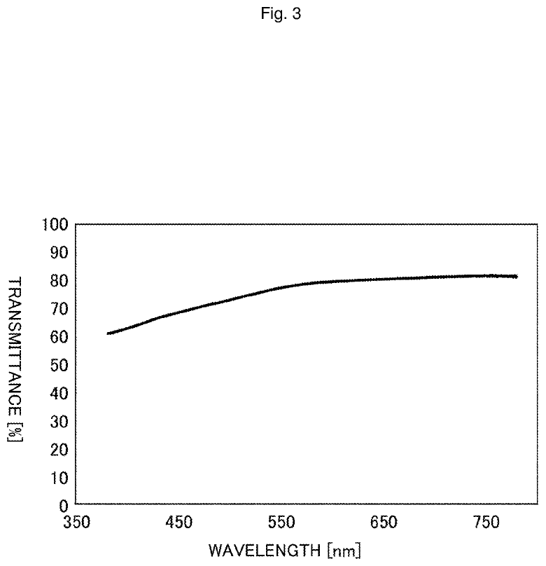

FIG. 3 shows the results of measuring the light transmittance in the visible light region of the lithium secondary battery using Li₃PO₄ of Example 1. The lithium secondary battery of Example 1 has a transmittance of 60% or more in the visible light region (about 400 nm to 780 nm). Similarly, the lithium secondary battery using Li_{6.25}La₃Zr₂Ga_{0.25}O₁₂ of Example 1 has a transmittance of 60% or more in the visible light region.

Therefore, it can be seen that the lithium secondary battery of Example 1 is a transparent battery that transmits visible light.

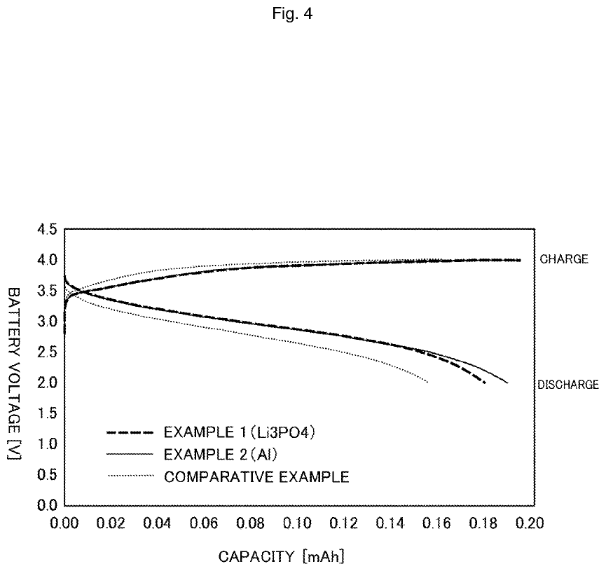

FIG. 4 shows initial charge/discharge curves of Example 1 and Example 2 and the comparative example which will be described later. In FIG. 4, the dashed line indicates the charging and discharging characteristics of a Li₃PO₄-added lithium secondary battery of Example 1. The solid line indicates the charging and discharging characteristics of the lithium secondary battery using Al for the thin film layer of Example 2, which will be described later. The dotted lines indicate the charging and discharging characteristics of the lithium secondary battery of the comparative example.

It can be seen from FIG. 4 that the lithium secondary battery in Example 1 is capable of reversible charging and discharging with a small irreversible capacity (difference between charging capacity and discharging capacity), the discharge capacity is about 0.179 mAh, and the average discharge voltage is about 2.97V.

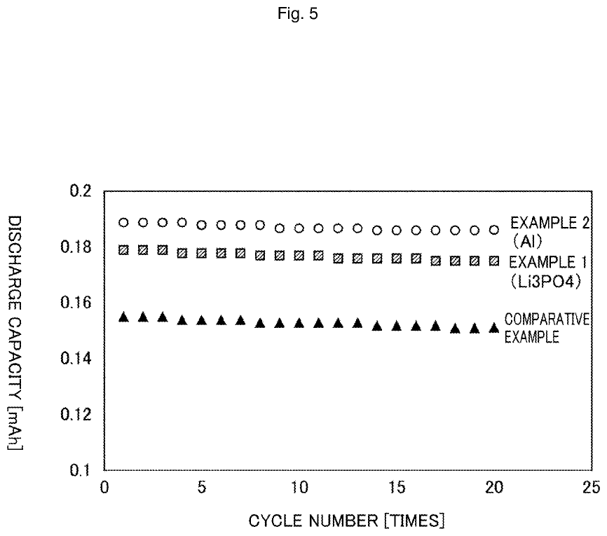

FIG. 5 shows discharge capacities from a first cycle to a 20th cycle of Example 1 and Example 2 and a comparative example which will be described later. It can be seen from FIG. 5 that the lithium secondary battery (Li₃PO₄) of Example 1 shows only a capacity decrease of about 0.004 mAh at the 20th cycle and has stable cycle characteristics.

Table 1 below shows the initial discharge capacity, the average discharge voltage and the discharge capacity at the 20th cycle of the lithium secondary battery of Example 1.

TABLE 1

| | | | | 20TH |
|---|---|---|---|---|
| | | Initial | Average | cycle |
| | | discharge | discharge | discharge |
| | | capacity | voltage | capacity |
| | | (mAh) | (V) | (mAh) |
| Embodiment | Li3PO4 | 0.179 | 2.97 | 0.175 |
| 1 | Li6.25La3Zr2Ga0.25O12 | 0.179 | 2.97 | 0.175 |
| Embodiment | Al | 0.189 | 2.98 | 0.186 |
| 2 | Cu | 0.187 | 2.97 | 0.183 |
| | Ag | 0.192 | 3.01 | 0.188 |
| | Au | 0.190 | 2.99 | 0.187 |

| | | | |
|---|---|---|---|
| Comparative example | 0.155 | 2.75 | 0.151 |

As described above, the lithium secondary battery of the example transmits visible light and has high energy density with excellent charge-discharge cycle characteristics. Specifically, in the example, it is possible to realize a lithium secondary battery in which the ion conductivity of the electrolyte is improved and stable charge-discharge cycles are possible by adding an inorganic compound (Li₃PO₄ or Li_{6.25}La₃Zr₂Ga_{0.25}O₁₂) used for a solid electrolyte to the polymer electrolyte 103.

Also, the lithium secondary battery of Example 1 has flexibility because the positive electrode 101 and the negative electrode 102 are formed on the flexible silicone rubber substrates 201 and 202.

### Example 2

A lithium secondary battery of Example 2 was prepared by the following procedure. The lithium secondary battery of Example 2 includes a thin film layer (current collector) containing at least one selected from the group consisting of Al, Cu, Ag, and Au between the transparent substrates 201 and 202 and the transparent conductive film 203. Here, four lithium secondary batteries in which Al, Cu, Ag, or Au was used were prepared for the thin film layers.

(Transparent Silicone Rubber Substrate with ITO)

In Example 2, as in Example 1, transparent silicone rubber substrates of 100 mm long×100 mm wide and 2 mm thick are used for the transparent substrates 201 and 202 of the positive electrode 101 and the negative electrode 102, respectively. Furthermore, a film was formed by coating each silicone rubber substrate 201 or 202 with Al, Cu, Ag, or Au to have a thickness of 10 nm through an RF sputtering method to form a thin film and forming a transparent conductive film 203 thereon by coating with ITO to have a thickness of 150 nm through an RF sputtering method. Sputtering was performed using an ITO (5 wt % SnO₂) target with an argon flow of 1.0 Pa and an RF output of 100 W.

### (Positive Electrode)

As in Example 1, a film of lithium cobaltate phosphate (LiCoPO4) with a thickness of 100 nm was formed as the positive electrode 101 on 90 mm long×100 mm wide of the silicone rubber substrate 201 on which the ITO film was formed through an RF sputtering method. Sputtering was performed using a LiCoPO4 ceramic target under the conditions of a flow partial pressure ratio of argon and oxygen of 3:1, a total gas pressure of 3.7 Pa, and an RF output of 700 W.

The positive electrode 101 thus formed has a portion of 10 mm long×100 mm wide in which the positive electrode material is not formed and the ITO is exposed. The exposed portion is used as the electrode terminal 301 of the positive electrode 101.

### (Negative Electrode)

As in Example 1, a 200 nm-thick lithium titanate (Li₄Ti₅O₁₂) film was formed as the negative electrode 102 through an RF sputtering method on 90 mm long×100 mm wide of a silicone rubber substrate 202 on which an ITO film was formed. Sputtering was performed using a Li₄Ti₅O₁₂ceramic target under the conditions of a flow partial pressure ratio of argon and oxygen of 3:1, a total gas pressure of 4.0 Pa, and an RF output of 700 W.

The negative electrode 102 thus formed has a portion of 10 mm long×100 mm wide in which the negative electrode material is not formed and the ITO is exposed. The exposed portion is used as the electrode terminal 302 of the negative electrode 102.

### (Electrolyte)

In the example, a polymer electrolyte in which an inorganic compound (Li₃PO₄) was added to the electrolyte 103 was used. Specifically, a polyvinylidene fluoride (PVdF) powder as a binder, a Li₃PO₄ powder, an organic electrolyte prepared by dissolving 1 mol/L of lithium bistrifluoromethanesulfonylimide (LiTFSI) as a lithium salt in propylene carbonate (PC), and etrahydrofuran (THF) as a dispersion medium were mixed at a weight ratio of 3:1:6:10. A transparent film (polymer electrolyte) with a thickness of 0.1 mm was prepared by stirring the solution at 60° C. for 1 hour in dry air with a dew point of −50° C. or lower, pouring 50 ml of the solution into a petri dish of 200Φ, and vacuum-drying it at 50° C. for 12 hours.

### (Battery Preparation)

The production of the lithium secondary battery of the example is similar to that of Example 1.

### (Battery Performance)

In the charge/discharge test of the lithium secondary battery, charge/discharge was performed at a current density of 1 μA/cm² per effective area of the positive electrode 101 (negative electrode 102) using a commercially available charge/discharge measurement system. The charging/discharging test was performed within a voltage range of 4.0 V for the final charge voltage and 2.0 V for the final discharge voltage. The charge/discharge test of the battery was performed in a constant temperature chamber at 25° C. (atmosphere was a normal atmospheric environment).

Table 1 above shows an initial discharge capacity, an average discharge voltage, and a discharge capacity at a 20th cycle of the lithium secondary battery of Example 2. As shown in Table 1 and FIGS. 4 and 5, an energy density (discharge voltage, capacity) of the lithium secondary battery of the example was slightly improved compared to those of Example 1. This is probably because Al, Cu, Ag, and Au enhances a current collecting effect and lowers a resistance component of the battery.

Specifically, FIG. 4 shows initial charge/discharge curves of a lithium secondary battery using Al for the thin film layer. It can be seen from FIG. 4 that the lithium secondary battery of the example can be reversibly charged and discharged with a small irreversible capacity (difference between charge capacity and discharge capacity), has a discharge capacity of about 0.189 mAh, and has an average discharge voltage of about 2.98 V.

FIG. 5 shows a discharge capacity from the first cycle to the 20th cycle of the lithium secondary battery using Al for the thin film layer. It can be seen from FIG. 5 that the lithium secondary battery of the example shows only a decrease in capacity of about 0.003 mAh at the 20th cycle and has stable cycle characteristics.

As in Example 1, the lithium secondary battery produced in Example 2 has a transmittance of 60% or more in the visible light region (about 400 nm to 780 nm) and transmits visible light.

Also, as in Example 1, the lithium secondary battery of Example 2 has flexibility because the positive electrode 101 and negative electrode 102 are formed on flexible silicone rubber substrates 201 and 202.

### Comparative Example

In a comparative example, an ITO-attached silicone rubber substrate, a positive electrode and a negative electrode are produced in the same procedure as in Example 1.

### (Electrolyte)

A polymer electrolyte which did not contain an inorganic compound was used as the electrolyte 103 in the comparative example. In the comparative example, a polyvinylidene fluoride (PVdF) powder as a binder, an organic electrolyte solution in which 1 mol/L of lithium bistrifluoromethanesulfonylimide (LiTFSI) as a lithium salt was dissolved in propylene carbonate (PC) and tetrahydrofuran (THF) as a dispersion medium were mixed at a weight ratio of 4:6:10. A transparent film (polymer electrolyte) with a thickness of 0.1 mm was prepared by stirring the solution at 60° ° C. for 1 hour in dry air with a dew point of −50° C. or lower, pouring 50 ml of the solution into a petri dish of 200Φ, and vacuum-drying it at 50° ° C. for 12 hours.

### (Battery Preparation)

The polymer electrolyte 103 was formed to have a size of 90 mm long and 100 mm wide. The positive electrode 101 and the negative electrode 102 are pinched so that the film-forming surfaces of the polymer electrolyte 103 face each other and only the film-forming surfaces are entirely covered and the transparent substrate 201 of the positive electrode, the polymer electrolyte 103, and the transparent substrate 202 of the negative electrode overlap. The edge of 90 mm long×100 mm wide of the overlapped part in which the positive electrode 101, the polymer electrolyte 103, and the negative electrode 102 overlapped was sealed with an adhesive 104. In addition, before the adhesive 104 was hardened, it was placed in a vacuum dryer and vacuum-dried to solidify the adhesive 104 to prepare a lithium secondary battery.

### (Battery Performance)

In the charge/discharge test of the lithium secondary battery, charge/discharge was performed at a current density of 1 μA/cm² per effective area of positive electrode 101 (negative electrode 102) using a commercially available charge/discharge measurement system. The charging/discharging test was performed within a voltage range of 4.0 V for the final charge voltage and 2.0 V for the final discharge voltage. The charging/discharging test of the lithium secondary battery was measured in a constant temperature chamber at 25° C. (atmosphere was a normal atmospheric environment).

As shown in FIGS. 4 and 5 and Table 1, the comparative example has a discharge capacity and an average discharge voltage lower than those of Examples 1 and 2. This is considered to be due to a decrease in the ionic conductivity of the polymer electrolyte 103 and an increase in the resistance of the current collector.

According to the above embodiment, a lithium secondary battery having visible light transmission, excellent charge-discharge cycle characteristics, and high energy density can be produced. Furthermore, the lithium secondary battery of the embodiment can be used as a drive source for various electronic devices.

Note that the present invention is not limited to the above embodiments and various modifications and combinations are possible within the technical idea of the present invention.

### REFERENCE SIGNS LIST

101: Positive electrode
102: Negative electrode
103: Electrolyte
104: Adhesive
201, 202: Transparent substrate (transparent silicone rubber substrate)
203: Transparent conductive film (ITO film)
301, 302: Electrode terminal

1. A lithium secondary battery, comprising:
a positive electrode capable of intercalating and deintercalating lithium ions;
a negative electrode capable of intercalating and deintercalating lithium ions; and
a solid electrolyte with lithium ion conductivity,
wherein the solid electrolyte contains an inorganic compound and a polymer.

2. The lithium secondary battery according to claim 1, which
has a transmittance of 60% or more in the visible light region.

3. The lithium secondary battery according to claim 1, wherein the inorganic compound contains at least one selected from the group consisting of Li₃PO₄ and Li_{6.25}La₃Zr₂Ga_{0.25}O₁₂.

4. The lithium secondary battery according to claim 1, wherein the positive electrode and the negative electrode are formed on respective substrates on which conductive films are formed, and
a thin film layer containing at least one selected from the group consisting of Au, Ag, Cu, and Al is formed between the substrate and the conductive film.

5. A method of producing a lithium secondary battery, comprising:
a step of forming a film of a positive electrode capable of intercalating and deintercalating lithium ions on a first substrate on which a conductive film is formed;
a step of forming a film of a negative electrode capable of intercalating and deintercalating lithium ions on a second substrate on which a conductive film is formed; and
a step of disposing a solid electrolyte containing an inorganic compound and a polymer between the first substrate and the second substrate.

6. The method of producing a lithium secondary battery according to claim 5, wherein the step of forming the positive electrode includes forming a thin film layer containing at least one selected from the group consisting of Au, Ag, Cu, and Al between the first substrate and the conductive film, and
the step of forming the negative electrode includes forming a thin film layer containing at least one selected from the group consisting of Au, Ag, Cu, and Al between the second substrate and the conductive film.

7. The lithium secondary battery according to claim 2, wherein the inorganic compound contains at least one selected from the group consisting of Li₃PO₄and Li_{6.25}La₃Zr₂Ga_{0.25}O₁₂.

8. The lithium secondary battery according to claim 2, wherein the positive electrode and the negative electrode are formed on respective substrates on which conductive films are formed, and
a thin film layer containing at least one selected from the group consisting of Au, Ag, Cu, and Al is formed between the substrate and the conductive film.

9. The lithium secondary battery according to claim 3, wherein the positive electrode and the negative electrode are formed on respective substrates on which conductive films are formed, and
a thin film layer containing at least one selected from the group consisting of Au, Ag, Cu, and Al is formed between the substrate and the conductive film.
